(19) United States
(12) Patent Application Publication
(10) Pub. No.: US 2010/0027798 A1
(43) Pub. Date: Feb. 4, 2010

(54) METHOD AND APPARATUS FOR STORAGE OF SECURE INFORMATION, WHICH IS REQUIRED FOR SHORT-RANGE COMMUNICATION, ON A COMMUNICATION TERMINAL

(75) Inventor: Eberhard Back, Kaufbeuren (DE)

Correspondence Address: OLIFF & BERRIDGE, PLC, P.O. BOX 320850, ALEXANDRIA, VA, 22320-4850, US

(73) Assignee: SMARTMACHINE INTERNATIONAL HOLDING GMBH, Oberndorf (AT)

(21) Appl. No.: 12/448,695

(22) PCT Filed: Jan. 24, 2008
(86) PCT No.: PCT/EP2008/000543

§ 371 Date: Sep. 24, 2009

(30) Foreign Application Priority Data
Feb. 8, 2007 (DE) 10 2007 006 384.0

(51) Int. Cl. H04L 9/08

(52) U.S. Cl. 380/279; 380/286

(57) ABSTRACT

A method of storing secure information that is required for a near-field communication on a communication terminal includes transmitting a request to store information and a key required for securing the information on the communication terminal from an issuer of the information to a central facility, transmitting the information and the key required for securing the information from the issuer via the central facility to the communication terminal when the central facility has confirmed the request to store the information and the key required for securing the information on the communication terminal, storing the information and the key required for securing the information in the communication terminal, and transmitting a notification relating to storing of the information and of the key required for securing the information from the communication terminal via the central facility to the issuer of the information, wherein the key required for securing the information is furnished by a central facility while being uniquely allocated to the secure information.

### TECHNICAL FIELD

The present invention relates to a method and an apparatus for storing secure information that is required for a near-field communication on a communication terminal. The operations to be executed in this method and in this apparatus, in particular with regard to processing of Mifare® objects defined and described in the present, are subsumed under the term NFC Service-Discovery, or Service-Discovery, with a view to obtaining trademark protection for the latter.

### PRIOR ART

From the prior art two different approaches for storing information on a near-field communication chip or NFC chip are known, NFC being the abbreviation for Near Field Communication. The first approach consists of storing the information on a so-called Mifare® part of the NFC chip, while the second approach consists of using a so-called SmartMX® part which is a smart-card implementation.

The SmartMX® part is a smart-card implementation by means of Java-Card technology which complies with the ISO 14443-4 (T=CL) Standard and has therefore already been specified in its entirety.

The Mifare® part of the NFC chip is an implementation of the Mifare® specification which complies with the ISO 14442 Standard. In other words, the NFC chip merely is a RFID chip, with RFID being an abbreviation for Radio Frequency Identification, having an additional storage area of one kilobyte, or 1 kB, for an implementation with a Mifare®-1k part.

FIG. 1 shows a representation of a storage area of a Mifare®-1k part.

In accordance with the representation in FIG. 1, the storage area consists of sixteen sectors of four 16-byte blocks each. Every fourth block in a sector, i.e., block 3 in every sector, includes an obligatory or mandatory key A of 6 bytes, four bytes of obligatory access bits, and an optional key B of 6 bytes. Accordingly there exists a maximum of 64−10=54 bytes per sector that are freely available, even though this amounts to reduced security due to non-use of the key.

In sector 0, block 0 is reserved for manufacturer data, thus reducing the freely available storage area by another 16 bytes. Accordingly, the maximum freely available storage area in a field having standard security (key B is used) is 16×48−16=752 bytes, which may be raised to 16×54−16=848 bytes (key B is not used).

The access bits in block 3 in every sector are also stored inversely to allow their validation. The access bits are used to define reading and writing authorizations on a block basis. In order to access some part of an information item in a sector, at least the obligatory key A must be furnished. This may change depending on the access bits set for this sector. For example, there might be a case where key B is required for writing some part of an information item into some block in some sector.

While the storage structure of the Mifare®-1k part described in the foregoing furnishes high security, it might detract from the openness of the Mifare®-1k part under certain circumstances. When a user chooses to store information in a given sector, sets the required one(s) of the keys A and B to a value known to himself exclusively, and sets the access bits such that this key cannot be changed any more, this part of the Mifare®-1k part becomes unusable for any other applications. This means that the entire memory of the Mifare®-1k part of the NFC chip may become blocked.

### OBJECT OF THE INVENTION

It is therefore the object of the present invention to eliminate the above-mentioned problems in the prior art and to furnish a method and an apparatus for storing secure information that is required for a near-field communication on a communication terminal, wherein the storage of the communication terminal is prevented from becoming unusable for any application.

### SUMMARY OF THE INVENTION

This object is achieved through the dispositions specified in claim 1 in terms of the method, and through the dispositions specified in claim 8 in terms of the apparatus.

Further advantageous aspects of the present invention are subject matter of the dependent claims.

### SHORT DESCRIPTION OF THE DRAWINGS

In the following, the present invention shall be explained in more detail by way of exemplary embodiments while making reference to the appended drawings, wherein:

FIG. 1 is a representation of a storage area of a Mifare®-1k part; and

FIG. 2 is a representation of a modified storage area of a Mifare®-1k part in accordance with the exemplary embodiment of the present invention.

### EXEMPLARY EMBODIMENT OF THE INVENTION

In general it should be noted that throughout the following description of the exemplary embodiment of the present invention, a storage area of a Mifare®-1k part of a near-field communication or NFC chip—with NFC being an abbreviation for Near Field Communication—with the exception of the modifications described in the following has the same structure as was described at the outset with regard to the prior art, so that the explanations given with regard to the prior art, with the exception of the modifications, equally apply to the exemplary embodiment of the present invention.

### First Exemplary Embodiment

One essential feature of the exemplary embodiment of the present invention is the concept of a so-called Mifare® object that is used in order to solve the problems mentioned in the foregoing.

A Mifare® object is an object holding information that is to be stored in a storage area of a Mifare®-1k part of a NFC chip, wherein it should be noted that the exemplary embodiments described in the following are not restricted to the Mifare®-1k part but any other configuration of a Mifare part may be used. Accordingly, although the designation Mifare® part will in the following be used for this part, it is nevertheless equally possible to use some other part capable of appropriately storing information in the manner that is described in the following.

The Mifare® object is used to represent application-specific data. The application-specific data covers a range from bus tickets to a virtual key for a user's house, etc.

In order to overcome a possibility of an entire chip being blocked, each Mifare® object has an associated issuer identification, or issuer ID, which is used as a key A. Access bits of each sector are set such that key A is required for both writing and reading.

The issuer ID is provided by a central facility which ensures issuer IDs to be unique. Besides information to be stored, a Mifare® object has several additional fields that shall be explained hereinbelow.

To be more precise, the following information is given for a Mifare® object:
Data: Data stored in a Mifare® object.
Optional data: Optional data not forming part of the afore-mentioned data, i.e., real data.
Issuer ID: Unique identification of the issuer of a Mifare® object.
Valid from: The date and time from when a Mifare® object is valid.
Valid until: The date and time until when a Mifare® object is valid.
Object type: Identification of a type of a Mifare® object.
Object sub-type: Identification of a sub-type of a Mifare® object.

Object type and object sub-type may be used for generating domain-specific types of Mifare® objects. One example of this would be a ticket issuer who issues a VIP ticket. In this case the object type would be “Ticket”, and the object sub-type “VIP.”

In order to be able to access data in a storage area of a Mifare® part of a NFC chip it is always necessary to provide a key A. In order to enable the use of a Mifare® part of a NFC chip, keys are furnished by a central facility. This serves two purposes. On the one hand, a developer of a Mifare® object need not have knowledge concerning a key that is required for this Mifare® object, and on the other hand the Mifare® part of the NFC chip cannot be blocked entirely.

In order to realize this, there is a platform which is in charge of storing both Mifare® objects and Java-Card applets or cardlets, without an issuer of a Mifare® object having to know a key that is used for storing a Mifare® object. Apart from storing Mifare® objects, this platform is equally in charge of updating and removing or cancelling Mifare® objects and cardlets. These operations shall in the following be described in more detail.

In accordance with the exemplary embodiment of the present invention, the NFC chip including the Mifare® part preferably is provided in a user's mobile terminal such as, e.g., a mobile phone.

In order to store a Mifare® object in a storage area of the Mifare® part of the NFC chip that is provided in a mobile terminal, an issuer, or a calculator or server etc. of the issuer etc., of the Mifare® object initially makes a request for an issuer ID with the central facility. Once the issuer has received the key (key A) and has the Mifare® object to be stored, the issuer performs a request at the platform with some parameters that will be described in the following. The platform responds to this request by a confirmation code that is used in order to enable an evaluation whether the platform approves of the request. As soon as storing the Mifare® object in a storage area of the Mifare® part of the NFC chip in the mobile communication terminal is completed, an asynchronous message is transmitted from the platform to the issuer of the Mifare® object to inform him of a storage status of the Mifare® object. In addition, the issuer of the Mifare® object receives a checksum of the stored data in the asynchronous message. This checksum is used for updating the data of the Mifare® object or deleting it from the mobile communication terminal.

Besides the given information for a Mifare® object that was already mentioned, the above-mentioned parameters additionally contain a MSISDN of a mobile communication terminal receiving the Mifare® object.

Storing a cardlet merely requires the cardlet and a MSISDN of a mobile communication terminal receiving the cardlet.

When a storage request arrives at the platform, first of all an examination as to correctness is performed. A status of this examination is returned to the issuer of the Mifare® object. Subsequently a connection between the platform and the mobile communication terminal is established by transmitting a SMS to a previously defined port number of the mobile communication terminal.

On the mobile communication terminal a dedicated midlet monitors arriving communications at the previously defined port. This midlet is referred to as a Java proxy, for it acts as a proxy for storing Mifare® objects.

The Java proxy establishes a connection to the platform by using a HTTPS connection and downloads the Mifare® object (or the cardlet) and the key (key A) from it in order to store it on the NFC chip in the mobile communication terminal. Following storing, a storage status is returned to the platform, to be passed on to the issuer by the platform. After the storing operation, the Java proxy forgets the key that was used for storing.

Following storing of a Mifare® object or of a cardlet, a situation may arise in which the Mifare® object has to be removed from the NFC chip, i.e., it has to be cancelled. As the key is required for accessing the Mifare® object, such cancellation or deletion is equally performed via the platform.

As the parameters for cancelling or deleting or removing a Mifare® object from the NFC chip of a mobile communication terminal, the issuer ID, the MSISDN of the receiving mobile communication terminal, and the checksum of the stored data, together with a cancellation request, are transmitted from the issuer to the platform.

Here the issuer ID again is the identification or ID that was allocated to the data, and the MSISDN is the mobile phone number through which the mobile communication terminal is to be connected. The checksum of the stored data is the checksum that was returned to the platform when the Mifare® object or the cardlet was stored.

The platform transmits a message to the Java proxy of the mobile communication terminal which furthermore establishes a secure connection with the platform. The mobile communication terminal downloads the checksum from the platform, compares it to the data stored on the NFC chip, and deletes the data stored on the NFC chip in the event of a match. After this, the operating status is returned from the mobile communication terminal to the platform.

The key is equally required for updating secure information, i.e., a Mifare® object, on the NFC chip. For this reason, the platform is used as a go-between between the issuer wishing to update the secure information and the mobile communication terminal. For this purpose the platform furnishes an updating method which merely acts as a convenient method for initially deleting the secure information and then newly storing a new secure information. Herefor the checksum of the stored data in addition to the parameters required in storing is transmitted together with the update request.

In order to provide an optimal user experience, the mobile communication terminal must be capable of finding data as quickly as possible. There are, however, cases in which not all Mifare® objects can be stored in the storage area of the Mifare® part of the NFC chip in the mobile communication terminal, for this storage area has a limited memory space of, e.g., 1 KByte. In this case data of Mifare® objects are stored in a RMS, with RMS being the abbreviation for Record Management System. The RMS is a secure location for storing data from within the midlet running on the mobile communication terminal. It is forcibly ensured that solely the midlet having stored an information item in the RMS may access this information item.

When the information is stored in the RMS, however, no external NFC reader device can access this information although this is required. For this reason a retrieval model was specified which outsources Mifare® objects from the RMS into the storage area of the Mifare® part of the NFC chip in the mobile communication terminal, and vice versa.

In order to implement such retrieval, it is determined that the midlet shall become active at predetermined intervals such as, for instance, every hour. The midlet includes a table of Mifare® objects stored in the RMS, and every time it becomes active it searches this table. When it comes across a Mifare® object that is valid at this point of time or becomes valid at the next predetermined interval, it attempts to store the Mifare® object in the storage area of the Mifare® part of the NFC chip in the mobile communication terminal. If the storage area of the Mifare® part of the NFC chip in the mobile communication terminal is already occupied, the Mifare® object having the shortest validity starting from this point of time is deleted.

In order to furnish the optimal user experience, there exists a protocol between the mobile communication terminal and an independent reader device for reading from the storage area of the Mifare® part of the NFC chip in the mobile communication terminal. The reader device should, for example, be capable of finding an information it is looking for without an interaction with a user. An interaction with a user may occur when two Mifare® objects or cardlets may be used for terminating an operation. In this case the user is asked to select the Mifare® object or cardlet he wishes to use. In order to enable this, the mobile communication terminal and the reader device should comply with the protocol used. This protocol shall be described in the following.

In the prior art there is presently no general location on a Mifare® part of a NFC chip that might be used to delay reading of an information item to a reader device, which is moreover not required in the market targeted by Mifare applications. An information is written once into in a storage area of a Mifare® part and may be read out from there many times.

This is, however, changing with a spreading NFC technology. With a device configured for NFC technology it is possible for this device to be both a reader and a writer device. This makes it possible to interact with a reader device and update or process information in a storage area of a Mifare® part of a NFC chip of the device. The reader device and the device do, however, have to be in agreement where data should be stored and retrieved. For this reason, the concept of a general GCB is used, with GCB being the abbreviation for General Communication Block.

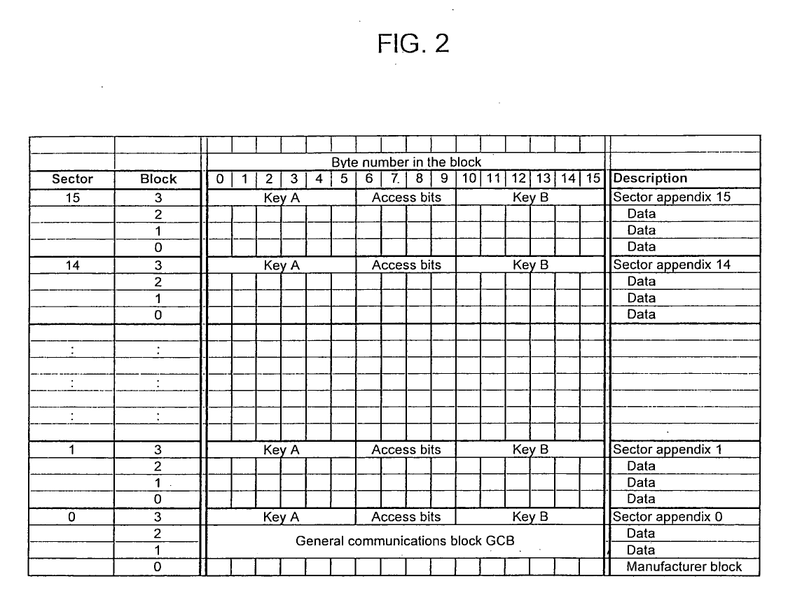

FIG. 2 shows a representation of a modified storage area of a Mifare®-1k part in accordance with the exemplary embodiment of the present invention, wherein a GCB is being used.

The GCB is used in order to admit an exchange of information between the independent reader device and the device. The GCB is located on the first sector—i.e., sector 0—of the Mifare® part of the NFC chip in the mobile communication terminal. This sector is already being used for storing manufacturer data.

FIG. 2 shows the storage structure of the Mifare® part of the NFC chip in the mobile communication terminal, with the GCB located in sector 0. Sector 0 is selected for the GCB because the manufacturer block is already stored in it and because this sector is already not usable for most purposes.

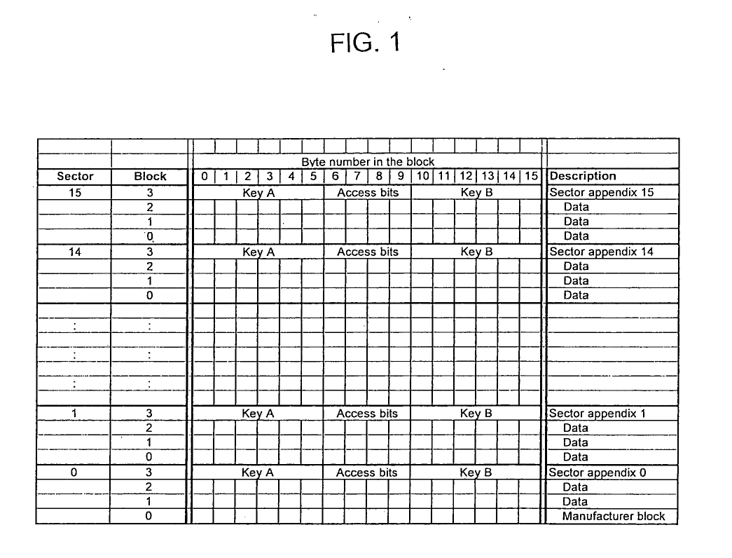

It should be noted that apart from this, the storage structure shown in FIG. 2 is identical with the storage structure shown in FIG. 1.

When a reader device wishes to access a Mifare® object in a storage area of a Mifare® part of a NFC chip in a mobile communication terminal, it must first of all know the key of the Mifare® object. In the following it shall be assumed that the reader device knows the key of the Mifare® object it wishes to access.

If the reader device detects that the mobile communication terminal is located in the vicinity, it attempts to read each sector of the storage area of the Mifare® part of the NFC chip in the mobile communication terminal by using the key of the Mifare® object it is searching for. Once the Mifare® object has been found, the reader device reads the information and terminates the operation, for the Mifare® object is retrieved directly.

If, however, the information—i.e., the Mifare® object—is not already stored in the storage area of the Mifare® part of the NFC chip in the mobile communication terminal, there is no sector in the storage area of the Mifare® part of the NFC chip in the mobile communication terminal that might be accessed by using the key, and the Mifare® object can not be retrieved directly.

In this case the key of the Mifare® object which the reader device wishes to access is stored in the GCB, and the operation is terminated. This generates an interrupt processing in the NFC chip causing the previously described midlet to be activated. The midlet, having read the key of the Mifare® object from the GCB, looks up the table of the Mifare® objects for the Mifare® object. If the Mifare® object is found in the table, a Mifare® object is outsourced from the storage area of the Mifare® parts of the NFC chip in the mobile telecommunication device into the RMS, and the requested Mifare® object is stored in its place. Then the sector number at which the Mifare® object is stored, followed by a termination symbol or token, is written into the GCB.

Following storing of the key in the GCB, the reader device waits for a predetermined time period and then periodically checks the contents of the GCB. When the reader device recognizes that the content of the GCB has changed, it reads the contents of the GCB and retrieves the sector number at which the Mifare® object is stored. Then the Mifare® object is retrieved from the given sector.

If, for some reason, the Mifare® object is too large to be stored in one sector, the mobile communication terminal may communicate this to the reader device by storing several sector numbers in the GCB prior to writing the termination symbol.

If the mobile communication terminal does not contain the Mifare® object searched for by the reader device, it writes nothing but a termination symbol into the GCB. The reader device finds this termination symbol only and takes from this that the requested Mifare® object is not available in the mobile communication terminal.

1. Method of storing a secure information that is required for a near-field communication on a communication terminal, the method including:
transmitting a request to store information and a key required for securing the information on the communication terminal from an issuer of the information to a central facility;
transmitting the information and the key required for securing the information from the issuer via the central facility to the communication terminal when the central facility has confirmed the request to store the information and the key required for securing the information on the communication terminal;
storing the information and the key required for securing the information in the communication terminal; and
transmitting a notification relating to storing of the information and of the key required for securing the information from the communication terminal via the central facility to the issuer of the information, wherein
the key required for securing the information is furnished by a central facility while being uniquely allocated to the secure information.

2. The method according to claim 1, wherein the information and the key required for securing the information are stored in a part of a chip of the communication terminal complying with ISO standard 14443A.

3. The method according to claim 1, wherein transmission of the information and of the key required for securing the information is performed by means of an object including at least the information and the key required for securing the information.

4. The method according to claim 3, wherein the information includes application-specific data, and the key required for securing the information includes a unique identification of the issuer.

5. The method according to claim 3, wherein the object further includes at least one selected from the group including optional data not being part of the information, data relating to a period of validity of the information, and data relating to a type/sub-type of the information.

6. The method according to claim 1, wherein the notification concerning storing of the information and of the key required for securing the information includes a storage status of the information and of the key required for securing the information and a checksum of the stored information.

7. The method according to claim 1, wherein the information and the key required for securing the information are retrieved from a near-field communication reader device by means of a near-field communication.

8. Apparatus for storing a secure information that is required for a near-field communication on a communication terminal, the apparatus comprising:
means for transmitting a request, an information, and a key required for securing the information on the communication terminal from an issuer of the information to a central facility;
means for transmitting the information and the key required for securing the information from the issuer via the central facility to the communication terminal when the central facility has confirmed the request to store the information and the key required for securing the information on the communication terminal;
means for storing the information and the key required for securing the information in the communication terminal; and
means for transmitting a notification concerning storing of the information and of the key required for securing the information from the communication terminal via the central facility to the issuer of the information, wherein
the key required for securing the information is furnished by a central facility while being uniquely allocated to the secure information.

9. The apparatus according to claim 8, wherein the information and the key required for securing the information are stored in a part of a chip of the communication terminal complying with ISO standard 14443A.

10. The apparatus according to claim 8, wherein transmission of the information and of the key required for securing the information is performed by means of an object including at least the information and the key required for securing the information.

11. The apparatus according to claim 10, wherein the information includes application-specific data, and the key required for securing the information includes a unique identification of the issuer.

12. The apparatus according to claim 10, wherein the object further includes at least one selected from the group including optional data not being part of the information, data relating to a period of validity of the information, and data relating to a type/sub-type of the information.

13. The apparatus according to claim 8, wherein the notification concerning storing of the information and of the key required for securing the information includes a storage status of the information and of the key required for securing the information and a checksum of the stored information.

14. The apparatus according to claim 8, wherein the information and the key required for securing the information are retrieved from a near-field communication reader device by means of a near-field communication.
